(19) United States
(12) Patent Application Publication
(10) Pub. No.: US 2013/0332179 A1
(43) Pub. Date: Dec. 12, 2013

(54) COLLABORATIVE IMAGE VIEWING ARCHITECTURE HAVING AN INTEGRATED SECURE FILE TRANSFER LAUNCHING MECHANISM

(71) Applicant: CALGARY SCIENTIFIC INC., CALGARY (CA)

(72) Inventor: Kenneth Gregory Scott Girard, Burlington (CA)

(73) Assignee: CALGARY SCIENTIFIC INC., CALGARY (CA)

(21) Appl. No.: 13/911,209

(22) Filed: Jun. 6, 2013

Related U.S. Application Data
(60) Provisional application No. 61/656,082, filed on Jun. 6, 2012.

(51) Int. Cl. G06F 19/00; G06Q 50/22

(52) U.S. Cl. CPC G06F 19/321; G06Q 50/22
USPC 705/2

(57) ABSTRACT

Systems and methods for providing a medical imaging application having a collaboratively-based secure file transfer mechanism. In accordance with some implementations, the medical imaging application may provide a user interface wherein a particular patient record may be selected by user. The medical imaging application may then launch an image viewer wherein the user may view and manipulate patient image data. From within image user interface, a collaboration session may be launched such that multiple users may view and manipulate the patient image data together. The users may be remotely located to a host facility where the patient data is stored. If it is determined that a patient should be transferred from the host facility to another facility, then from within the collaboration session, a user at the host facility may initiate a secure data transfer of the patient image data and other patient information to a receiving facility.

This application claims priority to U.S. Provisional Patent Application No. 61/656,082, filed Jun. 6, 2012 and entitled “Image Viewing Architecture Having Integrated Collaboratively-Based Secure File Transfer Mechanism,” which is incorporated by reference in its entirety.

### BACKGROUND

Today in healthcare there exists a problem of moving patient data from one location to another. For example, if a patient has previous exams in a clinic or another hospital, it can be very difficult to retrieve those exams at a new center or treatment center. This often results in patients previous exams not being used or requires the patient to be rescanned potentially resulting in excess radiation. Where patient data is moved, it is often patients themselves that are provided a CD containing the exams, which are then transported to another location. The workflows associated with creating and ingesting CDs can be very costly and time consuming for the sites creating the CDs, and cumbersome for the receiving facility to ingest the patient data on the CDs into existing patient image data systems.

One attempt to address these problems is a secure transfer mechanism that has been developed to communicate patient image files between facilities. This eliminates the need for rescanning and the transportation and creation of CDs. Facilities that subscribe to such a mechanism can manage their data through a web interface and push or request data from other facilities that they may or may not be associated with. While this is an improvement to transporting CDs, it is solely a transfer mechanism.

### SUMMARY

Disclosed herein are systems and methods for providing a medical imaging application having a collaboratively-based secure file transfer mechanism. In accordance with some implementations, there is provided a method of initiating transfer of image data having associated metadata from a first location to a second location. The method may include: executing an image data viewing application that presents a user interface to a computing device for display of at least a portion of the image data; activating, from within the user interface, an electronic transfer mechanism having at least one data field, the at least one data field being used to initiate a transfer of the image data from the first location to the second location; and providing, by the image data viewing application, metadata to the electronic transfer mechanism to pre-populate the at least one data fields.

In accordance with other aspects, there is provided a method of initiating transfer of image data from a first location to a second location from within an image data viewing application having an integrated secure file transfer mechanism. The method may include: displaying at least a portion of the image data in a user interface of the image data viewing application; receiving an indication to launch the secure file transfer mechanism, the secure file transfer mechanism presenting a file transfer user interface having at least one data field that facilitates the transfer of the image data from the first location to the second location; pre-populating the at least one data field with predetermined information associated with the image data, the pre-populating being performed by the image data viewing application; and transferring the image data and predetermined information from the first location to the second location.

In accordance with yet other aspects, there is provided a method of initiating transfer of image data using an image data viewing application having an integrated secure file transfer mechanism. The method may include: presenting at least a portion of the image data in a user interface of the image data viewing application, the at least a portion of the image data being retrieved from a database associated with a first location; in response to an input received in the user interface, launching a file transfer user interface associated with the secure file transfer mechanism, the file transfer user interface having at least one data field; pre-populating the at least one data field with information associated with the image data; and transferring the image data and information from the database associated with the first location to a database associated with a second location.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example environment in which image data may be securely transferred from a source location to a destination location;

FIG. 2 illustrates an example workflow that may be performed in the environment of FIG. 1;

FIG. 3 illustrates another example workflow that may be performed in the environment of FIG. 1;

FIGS. 4, 5, 6, 7A, 7B and 7C illustrate user interfaces associated with the workflows of FIGS. 2 and 3;

FIG. 8 illustrates another operational workflow within the environment of FIG. 1;

FIG. 9 illustrates another operational workflow within the environment of FIG. 1;

FIG. 10 is a block diagram illustrating further details of the environment of FIG. 1; and

FIG. 11 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

Overview

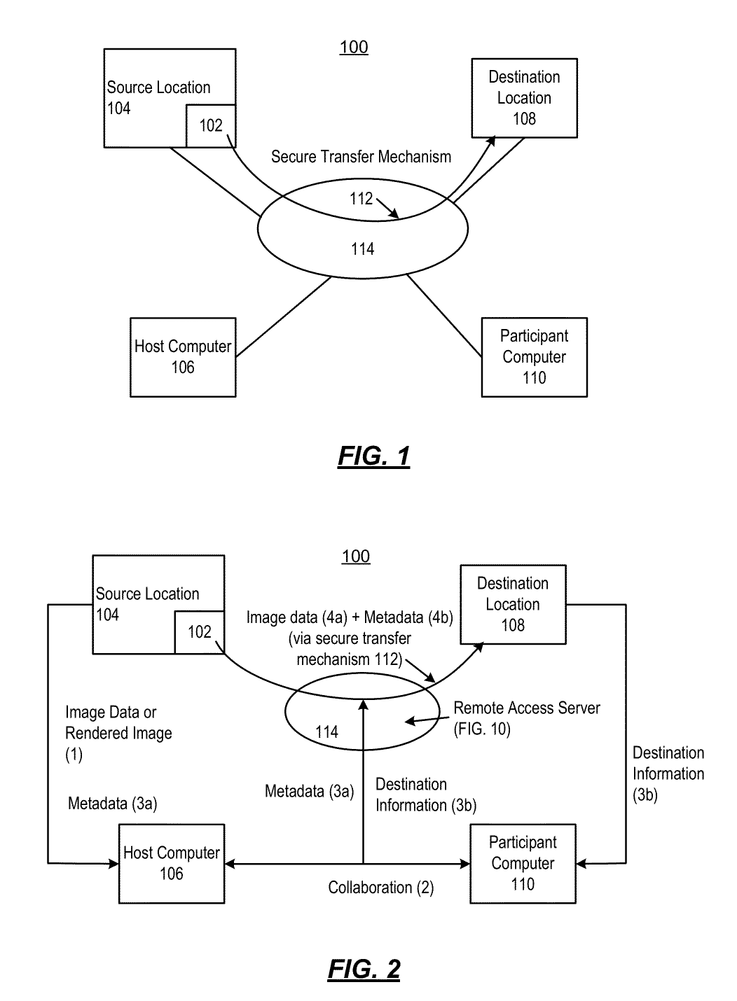

FIG. 1 illustrates an example environment 100 in which image data 102 may be securely transferred from a source location 104 to a destination location 108. In accordance with aspects of the present disclosure, a user of a data viewing application (e.g., a medical imaging application, such as RESOLUTIONMD, Calgary Scientific Inc.) executing on a host computer 106 associated with the source location 104 can initiate a transfer of image data (e.g., patient image data) from the source facility or location 104 to the destination facility or location 108 using a secure data transfer mechanism 112 that is launched from within a collaborative image viewing session between the host computer 106 and a collaborator at a participant computer 110 associated with the destination location 108. Although a single participant computer 110 and a single destination location 108 is shown in FIG. 1, the present disclosure is not limited to such a configuration, as it is contemplated that more than one participant computer 110 and more than one destination 108 may be in the environment 100. In some implementations, the source location 104 may be a facility where a patient is presently undergoing care and the destination location 108 may be a facility to which the patient may be transferred for additional care. As shown, the various entities may communicate with each other either directly or indirectly over a network 114.

Although the transfer of the image data is described as being initiated by the host computer 106, any participant in the collaborative image viewing session may initiate the transfer of image data. Further, participants need not be using computing devices associated with a particular location.

### Example Workflows

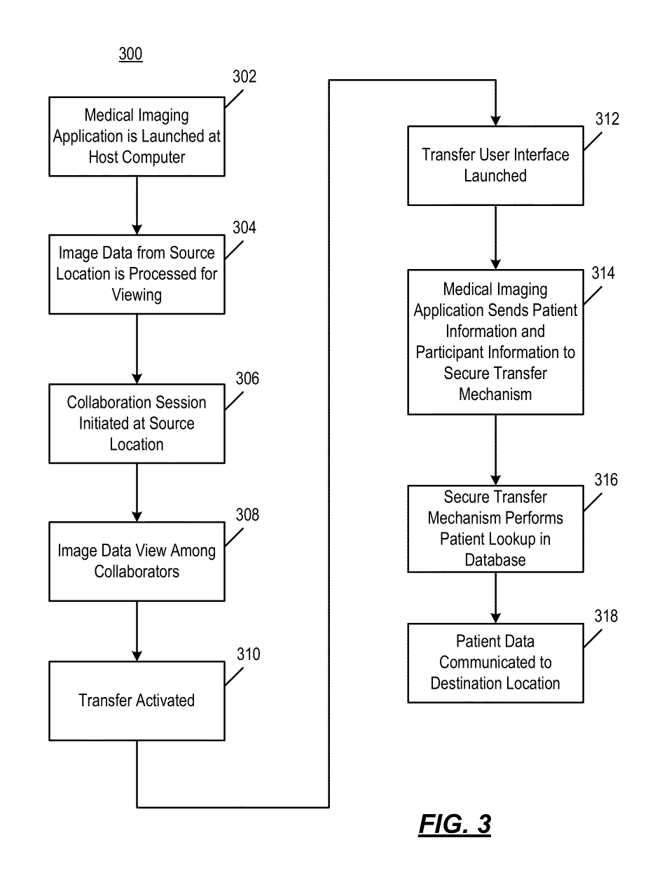

FIG. 2 illustrates an example workflow that may be implemented in the environment 100 of FIG. 1. Initially, a user at the host computer 106 associated with a rural facility or hospital (the source location 104) may be viewing at least a portion of the image data 102 Step 1). The image data may be processed on a remote server, in which case a rendered view is sent to the host computer, or the image data itself may be sent to the host computer for processing. The user at the host computer 106 may initiate a collaboration session by inviting a user who is operating the participant computer 110 associated with a larger urban healthcare center (the destination location 108) (Step 2). The users may collaborate to see if a patient needs to be transported to that larger facility.

From within the collaboration session, if it is determined that the patient will be transported to the larger healthcare center, the user operating the host computer 106 can select a transfer button that activates a Uniform Resource Locator (URL) that launches a transfer user interface associated with the secure data transfer mechanism 112. Metadata associated with the image data 102 and destination location information is provided to the secure data transfer mechanism 112 to pre-populate at least one data field of the transfer user interface (Steps 3a and 3b). For example, the secure transfer mechanism 112 may perform an automatic lookup in a database to obtain the metadata, as well as automatically add the destination facility information associated with the participant computer 110, which is available from within the collaboration session. In some implementations, a user may select or enter the destination location 108. Next, the image data 102 (e.g., patient image data) is communicated with the metadata (e.g., the associated patient information) for ingestion at the destination location 108 (Steps 4a and 4b). For example, the transferred image data 102 may be stored in the destination location's imaging system.

Thus, the above workflow enables image data, such as patient data and information to be entered and manipulated in a manner such that it is made compatible with the receiving facility's database. A similar functionality may be provided with Virtual Tumor Boards where the participants may be sent the reviewed data for their own records, teaching facilities where there are grand rounds, and/or cases may be pushed into a teaching Picture Archiving and Communication Systems (PACS) database for later review.

In addition, the above workflow provides a level of assurance the correct image data is being transferred from the source location to the destination location, as at least some of the transfer information is pre-populated into the transfer user interface and the users collaborate to view the image data.

In some implementations, the secure data transfer mechanism may launch the medical imaging application. Such an implementation may be used when the receiving facilities or the specialist have access to both the secure data transfer mechanism and the medical imaging application. Users will be able to request studies that will be sent through the secure transfer mechanism. After the studies are received, users will be able to launch the medical imaging application to review the cases. A collaboration session may be started with other users to review the case with another facility or even the patient.

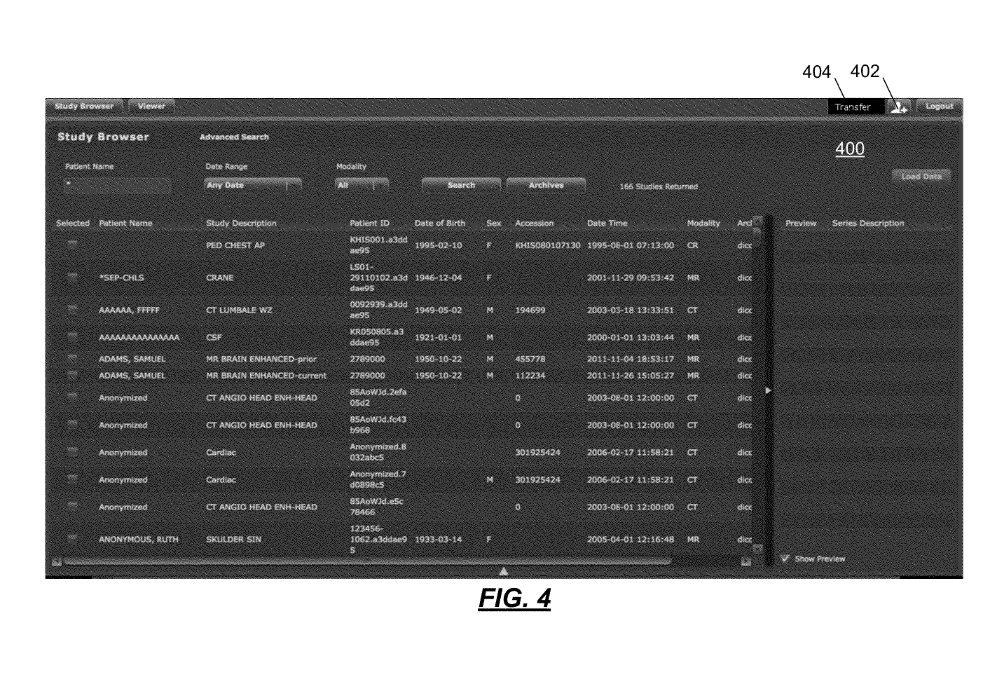

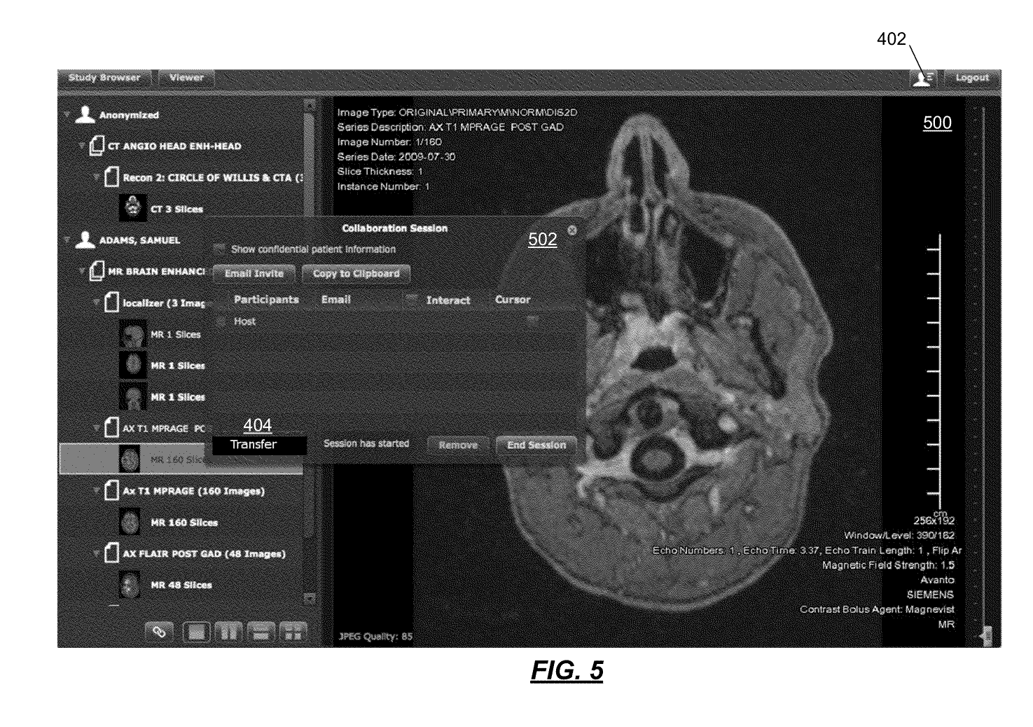

FIG. 3 illustrates a flow diagram 300 of another example workflow that may be performed within the environment of FIG. 1. The operational flow of FIG. 3 is another example that may be implemented in a data viewing application that is capable of initiating a collaborative session. FIGS. 4-7 illustrate user interfaces associated the operations performed in FIG. 3.

At 302, the medical imaging application is launched at the host computer associated with the source location. For example, a user at the host computer 106 may interact with the medical imaging application by accessing a server at the source location. As will be described below, the host computer may be a diagnostic workstation that accesses a computer server at the source location 104 that serves image data from a PACS database and/or rendered images from the image data. At 304, the image data from the source location is processed for viewing at viewing application. For example, the image data may be patient image data, and as shown in FIG. 4, a user interface 400 may be launched that lists patient image data files (studies) that are resident within a local PACS database of the source location 104. As shown, the user interface 400 enables a user to sort records by patient name, date range, modality, etc. to sort the results. Once the user selects a particular record in the user interface 400, patient image data may then be transferred from the PACS database at the source location 104 to the medical imaging application for viewing and interaction by the user at the host computer 104. A collaboration button 402 and a transfer button 404 are provided to invite other users to view image data (as rendered views) and transfer the image data, respectively, as described below.

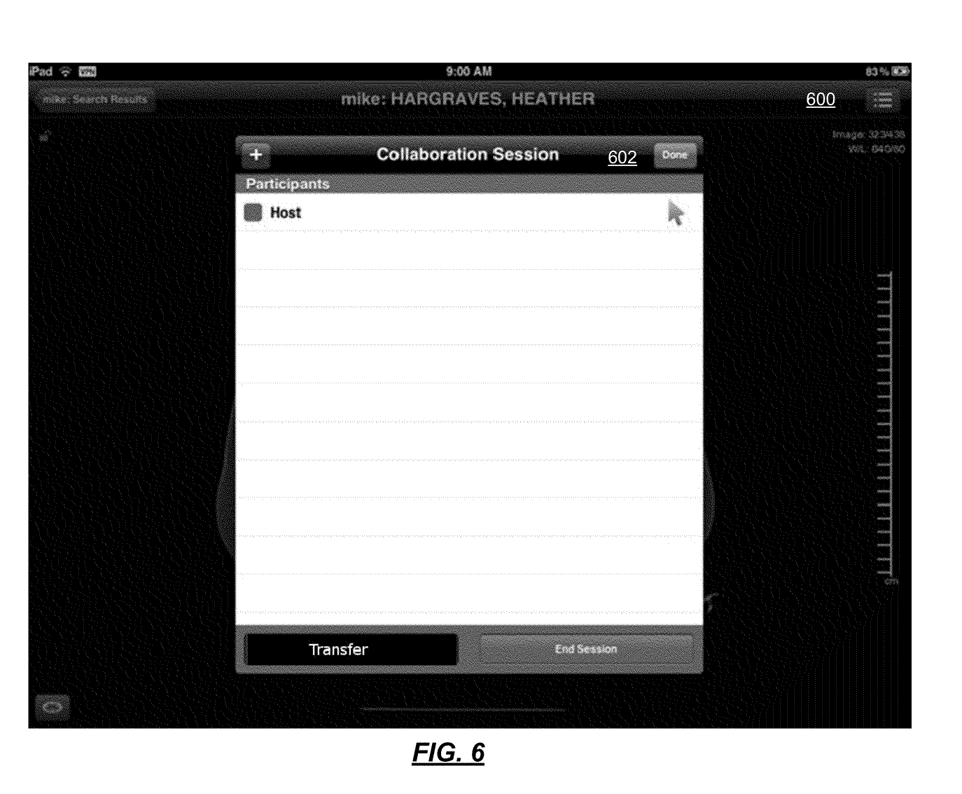

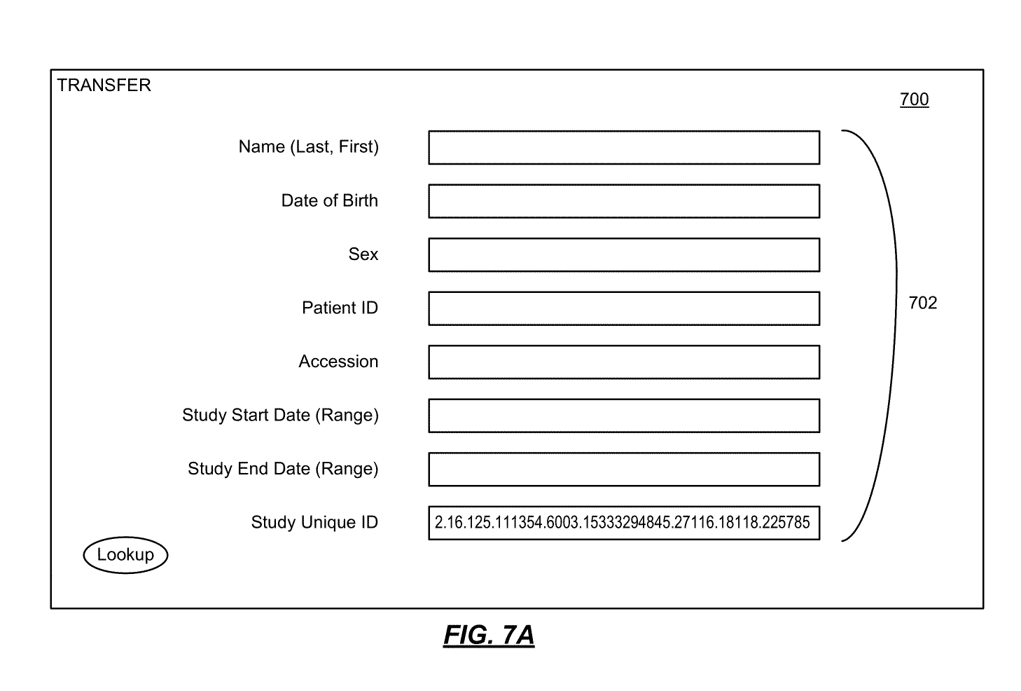

At 306, a collaboration session may be initiated by the host computer. For example, as shown in FIG. 5, when the user is viewing the patient image data in a user interface 500 on the host computer 106, the user may start a collaboration session by pressing the collaboration button 402 to launch a collaboration session window 502 to invite others to connect to the session to view the imagery shown in the user interfaces 500. Similarly, as shown in FIG. 6, there is illustrated a user interface 600 that may be presented on e.g., a mobile device such as an iPad, to enable a user to launch a collaboration window 602 to connect others to the session. In accordance with aspects of the present disclosure, user interfaces may be presented that are adapted for the type of client computing device that is part of the collaboration session.

As shown in FIG. 5, the user may communicate invitations to perspective participants, who upon clicking a URL in an e-mail, SMS message, etc., will be connected to the collaborative session, as described above. Thus, at 308, image data may be viewed among the collaborators in the session. During the collaborative session, the collaborators may manipulate the patient image data to ascertain information regarding a patient's condition. The collaborators may view the patient image data and make a decision regarding treatment, for example, to transfer a patient to another facility. At 310, a host collaborator may activate the transfer button 404, which may be provided within the collaboration session window 400 or 502 to initiate the patient image data transfer, as follows.

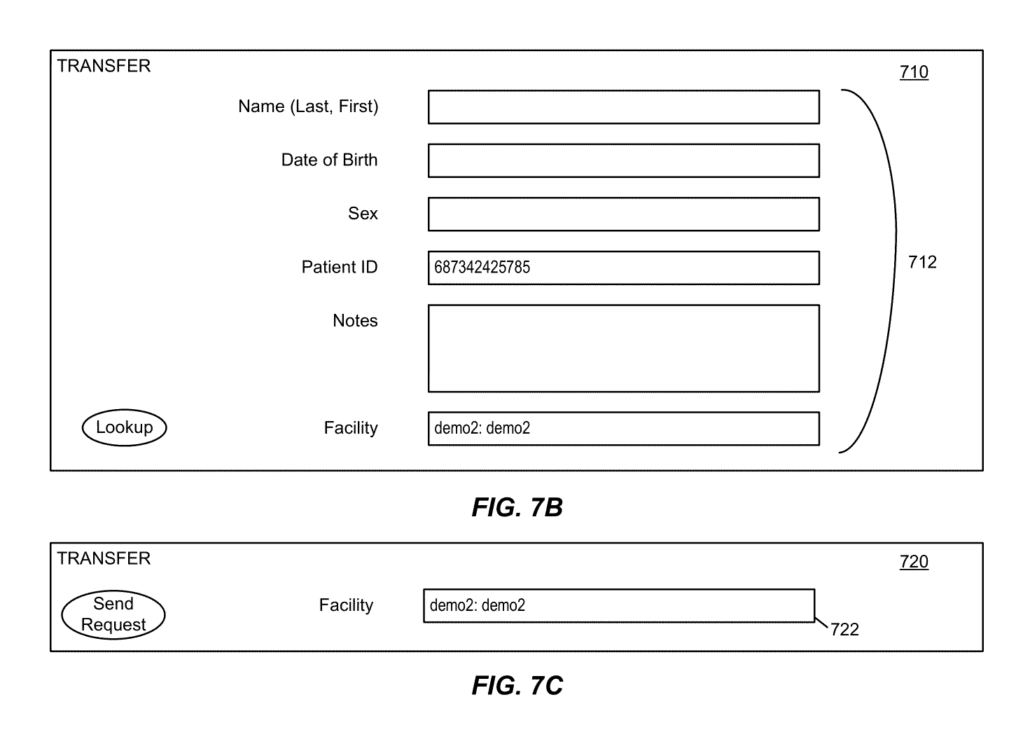

At 312, a transfer user interface is launched. The launching of the transfer user interface is integrated into the collaborative image viewing application and may be accessed by a URL that is launched when the transfer button 404 is activated. As shown in FIGS. 7A-7C, one of transfer user interfaces 700, 710 or 720 may be associated with a secure data transfer mechanism, such as BEAM, available from OneMedNet, of Seattle, Wash., USA. Similar mechanisms exist, such as those made available by LifeImage, of Newton, Mass., USA. As shown, the user interfaces 700, 710 or 720 may include one or more data fields 702, 712 or 722 that identify a patient record to be transferred. The fields 702, 712 or 722 may include, but are not limited to, a patient name, patient date of birth, sex, patient ID, accession, study start date range, study end date range, a study UID, etc. The fields 702, 712 or 722 may be pre-populated with data that is known to the medical imaging application. The fields 702, 712 or 722 may also be populated with data that is supplied by a user. Thus, the present disclosure reduces the likelihood of errors that may be introduced when entering patient or study information into the fields 702, 712 or 722. Data populated into the fields 702, 712 or 722 is transferred to the receiving facility with the patient data.

At 314, the medical imaging application sends patient information and the destination information to the secure data transfer mechanism. This may include the pre-populated information together with any additional user-added information provided in the data fields 702,712 or 722. The destination information may be determined by the participants in the collaborative session and the patient information may be obtained from the metadata associated with the image data. A user may select the destination location from a list generated from the participant information and/or enter the destination location to which the study will be communicated with the associated patient data for ingestion into the receiving facility's imaging system.

At 316, the secure transfer mechanism performs a patient lookup in a database of the source location. For example, the secure data transfer mechanism may access the PACS database to obtain the patient image data and other associated patient information. At 318, the patent data and other information are communicated to the destination location.

Thus, in accordance with the above, the patient image data is not moved to the destination facility until it is necessary. Meanwhile, users can collaborate through the medical imaging application to view the patient image data to arrive at a diagnosis or appropriate treatment or decision.

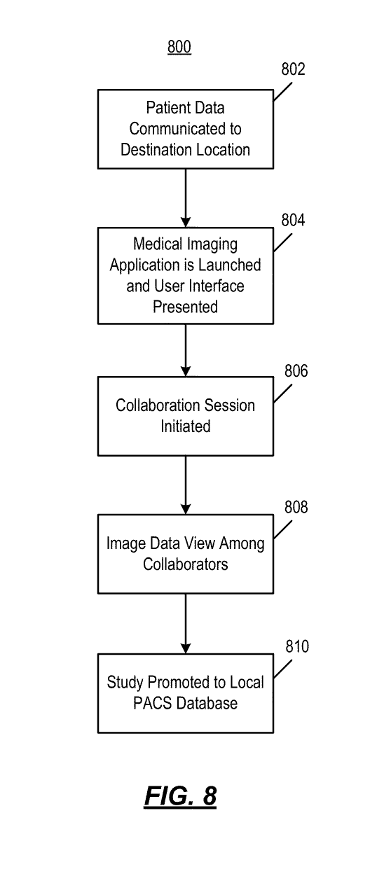

FIG. 8 illustrates a flow diagram 800 of example operations performed within the environment of FIG. 1. The operational flow of FIG. 8 may be implemented when, e.g., the host computer 106 may not have a data viewing application such as above. At 802, image data is communicated to the destination location. For example using the secure data transfer mechanism 112, the source location 104 may transfer the image data (e.g., patient data) to the destination location 108. At 804, the data viewing application (e.g., medical imaging application) at the destination location 108 may be launched and the user interface presented. For example, the user interface 400 of FIG. 4 may be presented such that a clinician at the receiving facility may view patient image data.

At 806, a collaboration session may be initiated. In order for medical personnel at the destination location 108 and others to view the image data, a collaboration session may be initiated, as described above. At 808, the collaborators may view the image data to, e.g. discuss the patient's condition. If it is decided that the receiving facility will take the patient's case, then at 810, the patient image data is promoted to the local PACS database (not shown). For example, the patient image data when initially transferred may be stored in a temporary repository. After it is decided that the patient will be transferred, then patient image data may be moved from the temporary repository to the PACS database.

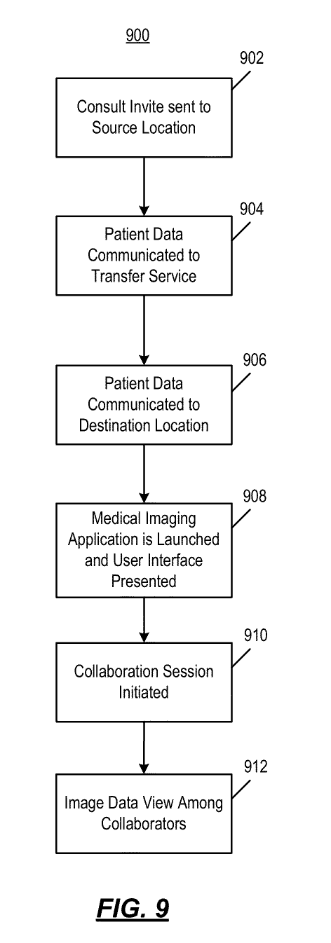

FIG. 9 illustrates a flow diagram 900 of example operations performed within the environment of FIG. 1. The operational flow of FIG. 9 may be implemented when, e.g., the source location 104 may not have local access to the secure data transfer mechanism 112. At 902, a consult invite may be sent to a source location 104 to upload image data (e.g., a patient study). For example, a destination location 108 may initiate a collaboration session within the data viewing application (e.g., medical imaging application) and invite a user from the source location 104 using the host computer 106 to join. The invitation may take the form of an e-mail, text message, etc., that is communicated from the medical imaging application to the user at the hosting facility.

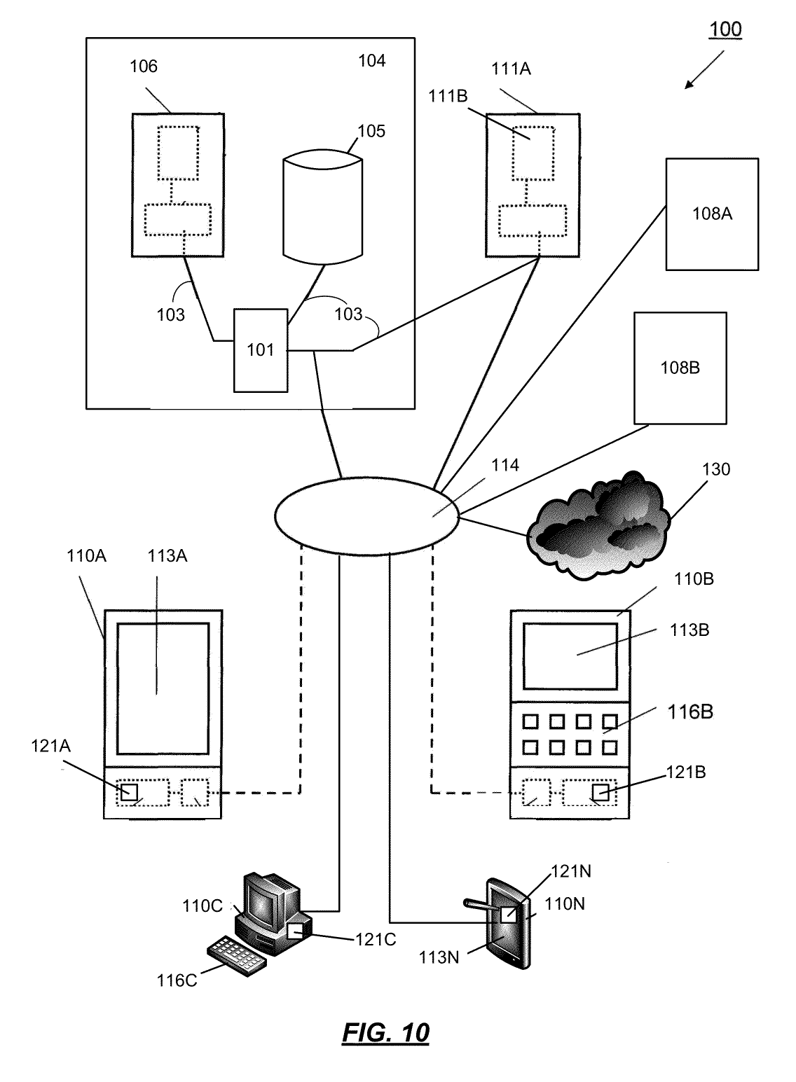

The user at the host computer 106 may accept invitation and, at 904, communicate the image data to a secure data transfer service provider. For example, a cloud service 130 (see, FIG. 10, below) may provide for the transfer and intermediate storage of data files from the hosting facility to the receiving facility. Alternately or additionally, image data (e.g., patient data files) and/or additional information may be retained and hosted at the cloud service 130 for remote viewing. At 906, the image data and/or additional information is communicated to the receiving facility. The destination location 108 may have a server computer that is adapted to communicate with the secure data transfer provider at the cloud service 130.

At 908, the data viewing application (e.g., medical imaging application) may be launched and the browser presented. For example, the browser of FIG. 4 may be presented such that a clinician at the receiving facility may view image data associated with the patient file. At 910, a collaboration session may be initiated. In order for medical personnel at the destination location 108 and others to view the patient image data, a collaboration session may be initiated as described above. At 912, the collaborators may view the patient image data to, e.g. discuss the patient's condition.

### Detailed Example Environment

FIG. 10 illustrates further details of the environment 100 that provides for patient image data viewing, collaboration and transfer via a computer network. A server computer 101 may be provided at the source facility 104 (e.g., a hospital or other care facility) within an existing network as part of a medical imaging application to provide a mechanism to access data files, such as patient image files (studies) resident within a, e.g., a Picture Archiving and Communication Systems (PACS) database 105. Using PACS technology, a data file stored in the PACS database 105 may be retrieved and transferred to, for example, a diagnostic workstation (host computer 106) using a Digital Imaging and Communications in Medicine (DICOM) communications protocol where it is processed for viewing by a medical practitioner. The diagnostic workstation may be connected to the PACS database 105, for example, via a Local Area Network (LAN) 103 such as an internal hospital network or remotely (not shown) via, for example, over the network 114 (a Wide Area Network (WAN) or the Internet). Metadata may be accessed from the PACS database 105 using a DICOM query protocol, and using a DICOM communications protocol on the LAN 103, information may be shared. The server computer 101 may comprise a ResolutionMD server available from Calgary Scientific, Inc., of Calgary, Alberta, Canada.

The server computer 101 may be one or more servers that provide other functionalities, such as a secure transfer mechanism whereby patient data files within the PACS database 105 may be communicated to one or more of other destination locations 108A and 108B. The destination locations 108A and 108B may each have a server, such as server computer 101 having one or both of the medical image application and the secure data transfer mechanism. The secure data transfer mechanism may retrieve information from the local PACS database 105 and transfer it to a remote receiving facility. The transfer may be point-to-point (e.g., directly from source facility 104 to the destination location 108A or 108B) or via a service, such as a cloud service 130 that may act as an intermediary to transfer the patient image data. The cloud service 130 may also host the patient image data. The secure data transfer mechanism may utilize the Secure Data Exchange (SDX) transfer protocol to create a secure transfer between endpoints.

A server 111A is connected, for example, via the network 114 or the Local Area Network (LAN) 103 to the source location 104 or the destination locations 108A or 108B, the cloud service 130 and one or more client computers 110A, 110B, 110C, 110N. As noted above, the client computers 110A, 110B may be associated with a respective one or more destination location 108A, 108B, whereas client computers 110C, 110N may not be associated with a respective destination location; however, they are able to join a collaborative session as participants. The server 111A includes a server remote access application 111B that is used to connect various client computers (described below) to applications, such as the medical imaging application provided by the server computer 101. The server remote access application 111B provides connection marshalling and application process management across the environment 100. The server remote access application 111B may field connections from remote client computers and broker the ongoing communication session between the client computers and the medical imaging application. For example, the remote access application 111B may be part of the PUREWEB architecture available from Calgary Scientific, Inc., Calgary, Alberta, Canada, and which includes collaboration functionality.

The client computers 110A and 110B may be wireless handheld devices such as, for example, an IPHONE, ANDROID device, WINDOWS PHONE or a BLACKBERRY connected via the network 114 such as, for example, the Internet, to the server 111A. Similarly, the participant computers may also include a desktop/notebook personal computer 110C or a tablet device 110N that are connected by the communication network 114 to the server 111A. It is noted that the connections to the network 114 may be any type of connection, for example, Wi-Fi (IEEE 802.11x), WiMax (IEEE 802.16), Ethernet, 3G, 4G, LTE, etc.

A client remote access application 121A, 121B, 121C, 121N may be designed for providing user interaction for displaying data and/or imagery in a human comprehensible fashion and for determining user input data in dependence upon received user instructions for interacting with the application program using, for example, a graphical display with touch-screen 113A or a graphical display 113B/113N and a keyboard 116B/116C of the client computers 110A, 110B, 110C, 110N, respectively.

Thus, the environment 100, through the server 111A, enables users to collaboratively interact with the medical imaging application. As such, a user at the diagnostic workstation (host computer 106) and each of the participating participant computers 110A, 110B, 110C . . . 110N may present a synchronized view of the display of the patient image data. It is noted that the host computer may also be a mobile device, and a participant may also be a remote computer may also be a diagnostic workstation.

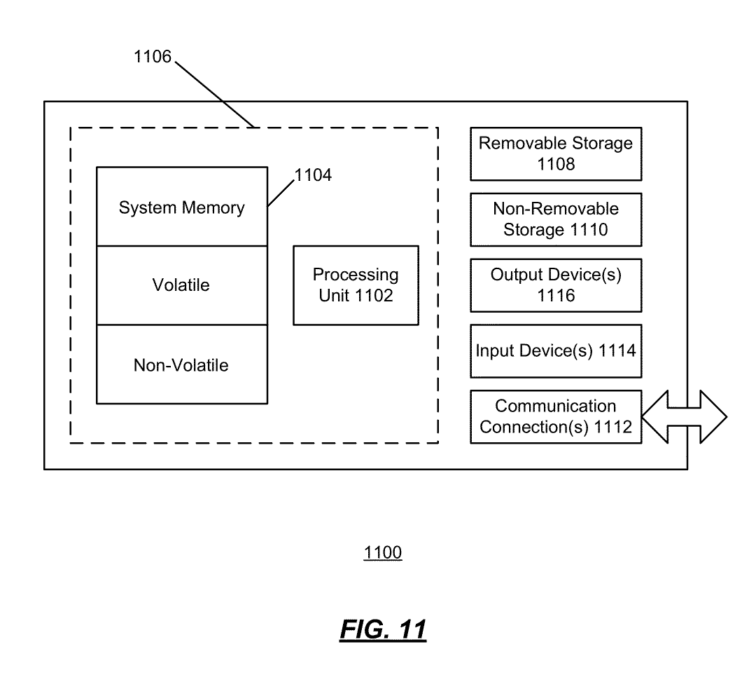

Alternatively or additionally, a user interface program is executed on the server 111A which is then accessed via an URL by a generic client application such as, for example, a web browser executed on the client computer 110A, 110B. The user interface is implemented using, for example, Hyper Text Markup Language HTML 5. Alternatively or additionally the server 111A may participate in a collaborative session with the participant computers 110A, 110B, 110C . . . 110N. The server 111A and the client computers 110A, 110B, 110C or 110N may be implemented using hardware such as that shown in the general purpose computing device of FIG. 11.

Although the present disclosure has been described with reference to certain operational flows, other flows are possible. For example, patient image data may be pushed from any interface of the medical imaging application. Context-level integration may be provided where the data is pushed in accordance with a particular collaborator that has requested the image data. For example, if a user in the collaboration session is at destination location 108A, then if that user requests the patient image data, then the data would be automatically routed to destination location 108A, rather than the host selecting destination location 108A. Also, the context-level integration may automatically determine that the patient image data is to be transferred to a test database or an educational database based. Further, in some implementations, a user within the collaboration session may initiate the transfer button to initiate the transfer. Still further, the source location 104, destination locations 108A, 108B and/or the cloud provided 130 may maintain an audit trail of where patient image data files are transferred. This information may be maintained to keep a record of where patient image data files are transferred for compliance purposes and/or to prevent redundant transfers among other reasons.

Also, while the present disclosure has been described with regard to patient image data and the sure transfer thereof between heath care facilities, it is noted that any type of image data may be collaboratively viewed and transferred between endpoints.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

FIG. 11 shows an exemplary computing environment in which example embodiments and aspects may be implemented. The computing system environment is only one example of a suitable computing environment and is not intended to suggest any limitation as to the scope of use or functionality.

With reference to FIG. 11, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communications connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of initiating transfer of image data having associated metadata from a first location to a second location, comprising:
executing an image data viewing application that presents a user interface to a computing device for display of at least a portion of the image data;
activating, from within the user interface, an electronic transfer mechanism having at least one data field, the at least one data field being used to initiate a transfer of the image data from the first location to the second location; and
providing, by the image data viewing application, metadata to the electronic transfer mechanism to pre-populate the at least one data fields.

2. The method of claim 1, further comprising receiving an indication of the second location within the electronic transfer mechanism.

3. The method of claim 1, wherein the electronic transfer mechanism receives a selection of the image data to be presented in the user interface.

4. The method of claim 3, further comprising retrieving the at least a portion of the image data from a database for display.

5. The method of claim 1, further comprising receiving an indication to activate a collaboration session from within the user interface to invite at least one remote computing device to synchronously present the at least a portion of the image data.

6. The method of claim 5, further comprising providing access to the collaboration session using a remote access server.

7. The method of claim 5, wherein the at least one remote computing device is associated with the second location.

8. The method of claim 1, wherein the image data viewing application is a medical imaging application.

9. The method of claim 1, further comprising transferring the image data and the associated metadata from the first location to the second location.

10. A method of initiating transfer of image data from a first location to a second location from within an image data viewing application having an integrated secure file transfer launching mechanism, comprising:
displaying at least a portion of the image data in a user interface of the image data viewing application;
receiving an indication to launch the secure file transfer mechanism, the secure file transfer mechanism presenting a file transfer user interface having at least one data field that facilitates the transfer of the image data from the first location to the second location;
pre-populating the at least one data field with predetermined information associated with the image data, the pre-populating being performed by the image data viewing application; and
transferring the image data and predetermined information from the first location to the second location for storing in a database associated with the second location.

11. The method of claim 10, further comprising:
retrieving the at least a portion of the image data from a database associated with the first location for display in the user interface; and
transferring the image data and predetermined information from the database associated with the first location to the second location.

12. The method of claim 10, further comprising initiating a collaboration session from with the user interface to invite at least one remote collaborator to synchronously view the at least a portion of the image data in a remote data viewing user interface associated with the at least one remote collaborator.

13. The method of claim 12, further comprising providing a mechanism such that each of collaborators may manipulate the at least a portion of the image data for display within the collaboration session.

14. The method of claim 12, wherein the at least one remote collaborator is associated with the second location, and wherein destination information regarding the second location is provided from the collaboration session to the secure file transfer mechanism.

15. The method of claim 10, wherein the predetermined information is contained within metadata associated with the image data.

16. The method of claim 15, further comprising storing the predetermined information as metadata in the database associated with the second location.

17. The method of claim 10, further comprising receiving additional information to populate other data fields of the file transfer user interface.

18. A method of initiating transfer of image data using an image data viewing application having an integrated secure file transfer launching mechanism, comprising:
presenting at least a portion of the image data in a user interface of the image data viewing application, the at least a portion of the image data being retrieved from a database associated with a first location;
in response to an input received in the user interface, launching a file transfer user interface associated with the secure file transfer mechanism, the file transfer user interface having at least one data field;
pre-populating the at least one data field with information associated with the image data; and
transferring the image data and information from the database associated with the first location to a database associated with a second location.

19. The method of claim 18, further comprising providing at least one of the database associated with the first location and the database associated with the second location as a cloud service.

20. The method of claim 18, further comprising retrieving the information associated with the image data from metadata stored in the database associated with the first location.

21. The method of claim 18, further comprising:
initially providing the at least a portion of the image data in a user interface of the image data viewing application from a temporary repository; and
promoting the image data from the temporary repository to the database associated with the first location prior to transferring the image data to the second location.

22. The method of claim 18, further comprising initiating a collaboration session from with the user interface to invite at least one remote collaborator to synchronously view the at least a portion of the image data in a remote data viewing user interface associated with the at least one remote collaborator.

23. The method of claim 22, wherein the at least one remote collaborator is associated with the second location, and wherein destination information regarding the second location is provided from the collaboration session to the secure file transfer mechanism.
